(19) United States
(12) Patent Application Publication
(10) Pub. No.: US 2004/0090594 A1
(43) Pub. Date: May 13, 2004

(54) Procedure for the formation of the tip of a support arm for spectacles and relative support arm with a permanent tip

(75) Inventor: Guido Medana, Valdobbiadene (IT)

Correspondence Address: John S. Egbert, Harrison & Egbert, 7th Floor, 412 Main Street, Houston, TX, 77002, US

(73) Assignee: FOVAL SRL, Valdobbiadene (IT)

(21) Appl. No.: 10/396,250

(22) Filed: Mar. 26, 2003

(30) Foreign Application Priority Data
Nov. 13, 2002 (IT) TV2002A000136

(51) Int. Cl. G02C 1/00

(52) U.S. Cl. 351/41

(57) ABSTRACT

Procedure to form a permanent tip in polymer, formed directly in correspondence with the end portion of a support arm in metallic wire for spectacles, in which a work cycle foresees at least the following phases: (a) preparation of a bath with a liquid solution which includes a polymer; (b) immersion in the bath of at least the end portion and, in the first case, of a support arm in metallic wire for spectacles without a coating; (c) removal of the support arm in metallic wire from the bath, according to a pre-determined speed; (d) movement of the support arm towards a solidification station for the solidification of the portion immersed in the bath; (e) if required, repetition of at least phases (b), (c) and (d). The support with the end coated by the polymer tip form a single piece with, at one end, a progressive reduction for the thickness of the tip which has been formed before the end of the support arm, and if required, with an enlargement of the end of the tip in the form of a droplet.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The object of this invention is a procedure for the formation of a coating element, especially in polymer, formed directly in correspondence with the end portion of a support arm, particularly in metal wire, for spectacles.

The proposal may be used especially, but not exclusively, in the sector involved in components for lightweight and ultra-lightweight spectacles.

### BACKGROUND OF THE INVENTION

Frames for spectacles are well known, and they are mainly made from a frame which is used to hold the lenses, that is, the front part, formed by the two rings of the spectacles which are joined together by an intermediate bridge, by nose-pads, which are sometimes formed monolithically together with the two rings and/or formed by the bridge, and by two support arms, one on each side of the frame.

Even though the level of originality of support arm solutions currently available on the market is not particularly high due to the abundance in the sector, there are still numerous suggestions aimed at bringing something new into the spectacles sector, suggestions which, however, have almost always concentrated mainly on the hinged part while overlooking the end portion of the support arm.

In the last decade, EP546589 (Lindberg) was certainly an interesting solution. The object of this solution is the support means for the lenses of the spectacles, especially the type with a wire frame. In the patent document, technical variations are also described, especially regarding the wire support structure for the lenses. In this case, the wire is made in such a way that it runs along only the upper part of each lens in one of the variations, or along the lower part of the lens in an alternative variation. As a result, a single structure is created by bending and folding the wire, which acts as a joint at the sides of the spectacles for hinging the arms and, by means of a bridge in the center, as a joint for the two lenses and as a fixing point for the respective nose-pads.

State of the Art

The solution mentioned above, in this case, was particularly significant because it brought the so-called “rimless” or “ultra-light” type of spectacles back onto the market, a type which the general public is especially fond of due to its unusual lightness and because they are less noticeable. This type was so appreciated that, even today, they are widely used, especially in the case of spectacles for correction purposes.

Going further into detail, all these solutions use support arms made from metallic wire with a more-or-less round section. The elements in question are basically straight, with one end shaped to form the hinge and the other end curved according to a conventional standard form in order to adapt itself to the natural seat at the back of the ear, and they propose the use of a tip or sheath made from a plastic material in correspondence with the curved part of the said support arm in metallic wire.

This tip is made up basically of a straight, relatively thin part which is tubular and closed, and which has a more-or-less constant, round section, with the outer surface formed at the opposite end of the opening having a hemispheric shape. Amongst the materials most commonly used for making this component there is silicone which, apart from having the advantage of being anallergic, forms a component which is relatively elastic and which gives easily when subjected to pressure. This component, because of its mechanical properties, has been used to cover a large part of the metallic wire support arms which are currently available on the market.

As opposed to other common types of tips, the said tubular covering element, once it has been formed according to well known production techniques, is still today simply handled in order to be slipped over the end part of the support arm in metallic wire during the assembly phase.

Regarding other types of tips, the traditional types which are slipped on later or formed directly in correspondence with the end part of the support arm are well known. In this case, another kind of rigid or semi-rigid plastic is used, the characteristic of which is given by the fact that, in correspondence with the opposite end to the opening, there is a kind of flattened droplet which is usually in line, or sometimes turned to one side. The closed hole, which is formed longitudinally with respect to the support arm, runs along right up to the part where there is the said droplet, so that the end of the metallic support arm does not come out of the section which is thicker. Other characteristics of the said tips may be summed up by the fact that the section. may be either round or polygon-shaped, while the material is usually transparent or semi-transparent, and sometimes opaline.

Regarding the technique used to manufacture the said tips, it is well known that they are usually made by means of injection moulding, while in some cases they are vulcanized.

On the basis of an initial verification of the most significant procedures, FR2619637 (Henri) is worth a mention. This describes a method for creating a tip which is not directly on the end of the support arm. It proposes a very thin, special sheath which has an outside diameter of approximately 2 mm, used to cover the ends of the support arms or the support arms for prescription glasses, sunglasses or protective glasses. The invention regards a silicone sheath with high mechanical, physical and chemical properties which is used to avoid the glasses slipping forward. At the same time, the said sheath offers higher protection against allergies to plastic and against irritation caused by the support arms pressing behind the ear or against the mastoid bone. As far as the procedure is concerned, it mentions the fact that the silicone material is inserted in the mould at variable pressure, and that vulcanization is then carried out at a temperature of approximately 120° C.

Regarding the product obtained with this procedure, the tip, at the opposite end with respect to the opening, has a droplet with a round section and a conical taper which is blended in line with the tubular or straight portion of the tip.

WO99/14627 (Spindelbalker) also suggests a. procedure for manufacturing tips, but in this case it mentions tips which are formed directly on the end part of the support arm. Going more into detail, a tube of plastic is inserted in correspondence with the end of a support arm in metallic wire in order to form a plastic sheath. The end part of the plastic tube is enclosed in an enlarged, droplet-shaped portion which is formed by injection moulding at the end of the said plastic tube and cut into sections, before being slipped on in correspondence with the free end of the metallic wire support arm. In this solution, it is to be noted that the droplet is formed according to a traditional shape, that is, with the two opposite faces which are more or less flat.

Drawbacks

In all of the cases mentioned above, whether the tips have a constant tubular section or a droplet shape, the said cover behaves as if it were a separate component with respect to the end portion of the support arm. From a practical point of view, this may lead to the annoying, progressive movement of the spectacles which gradually slip, thus pulling the support arms either forwards or backwards. In the first case, the result is a pair of spectacles with support arms whose tip more or less slips off, a condition which means that the wearer has to constantly put back in the correct the position. Otherwise, the tip may fall off which means the support of the spectacles will no longer be correct, apart from the fact that the metallic part will come into contact with the skin, leading to a series of disturbances connected with intolerance to various metals or alloys, or finishing treatments such as those which are nickel-based.

In some types of tip, especially those with a basically tubular and particularly elastic conformation such as those made from silicone, the opposite may occur. That is, because of the continuous action of putting on and taking off of the spectacles, the ends of the support arms may wear through the closed end of the sheath or tip. In this case, the spectacles will no longer sit correctly, and the end of the support arm will stick out from the covering sheath or tip. The most immediate consequence, if the tip is not put back into its correct position, is that the sharp end of the support arm will rub locally against the skin around the ear, which may lead to irritation or even an infection. A further negative effect is given by the fact that the metallic support arm, because it is no longer covered, comes into direct contact with the skin which may provoke dermatitis due to intolerance to metal, especially in the presence of normal perspiration.

With some types of tip, the problem could be solved by simply increasing its gripping capability. For example, the support arm could be subjected to further working during its manufacture, by creating a localized rougher surface or by forming a gripping hook or, in other cases, by locally reducing the diameter of the support arm at the end in order to form a kind of tooth along the arm itself, against which the opening of the tubular tip presses. It is quite clear, therefore, that while these operations may partially resolve the problem, these examples require extra work phases which lead to more time being involved and to higher production costs.

A further drawback, particularly in the type with constant-section tubular tips, lies in the fact that there is the annoying sensation of being able to feel the step between the tip and portion of support arm just before the end. In these cases, some proposals foresee a progressive reduction in the thickness of the tip in correspondence with the opening. This is the case in WO99/14627 (Spindelbalker). In this proposal, as in other similar proposals, the hold is virtually non-existent in this portion of the tip which, after a certain length of time, leads to it peeling off and breaking, which then increases the gap and increases the annoying sensation to the person wearing the spectacles.

The most common drawbacks again regard the constant-section tubular tips. In this case, the fact that there is longitudinal play due to detachment between the external interface of the end of the metallic support arm and the internal interface of the tip, means that dirt and liquids (perspiration, water, etc.) penetrate into the tubular cavity of the tip. In the case of neutral color or transparent tips, apart from creating a bacterial breeding ground, it leads to the tip becoming increasingly discolored, which from an aesthetic point of view is not at all pleasant.

In view of these introductory considerations, it is evident that it is important to find alternative solutions.

The aim of this invention is also to overcome the aforementioned drawbacks.

### BRIEF SUMMARY OF THE INVENTION

These and other aims are achieved with this invention according to the characteristics described in the attached claims, by solving the problems mentioned above by means of a procedure to form a coating element, in particular a permanent tip in polymer, formed directly in correspondence with the end portion of a support arm, for example in metallic wire for spectacles, in which a work cycle foresees at least the following phases:

(a) preparation of a bath with a liquid solution which includes a polymer;

(b) the immersion in the said bath (a) of at least the end portion and, in the first case, of a support arm in metallic wire for spectacles without a coating;

(c) removal of the support arm in metallic wire from the said bath, according to a predetermined speed;

(d) movement of the support arm towards a solidification station for the solidification of the portion immersed in the bath (a); (e) if required, repetition of at least phases (b), (c) and (d).

The support arm and tip formed by immersion in the bath thus obtained, appears with at least the end coated by the polymer tip firmly anchored to it, to form a single piece with, at one end, a progressive reduction of the thickness of the tip which has been formed before the end of the support arm, and, if required, with an enlargement of the end of the tip in the form of a droplet.

Advantages

In this way, by means of the significant creative content, which leads to an immediate technical progress, various advantageous objectives are reached.

The first objective is the creation of a support arm in metallic wire for spectacles with, in correspondence with at least the end part, a tip which is firmly attached to the metallic part. As a result, the movement of the tip with respect to the metallic wire support is impeded, thus overcoming the inconvenience of having to re-position the tip, but also eliminating the possibility of it being lost or of the end breaking off. Further to this, the health of the person wearing the spectacles is also safeguarded, since the stable position of the tip guarantees that the spectacles are held in the correct position and means that the metallic part of the support arm does not come into contact with the skin, thus improving its protective properties. Further, it must be pointed out that, by avoiding the longitudinal slipping and twisting of the tip, there is the advantage that the tip is kept in a perfect condition from a hygienic and aesthetic point of view, with virtually no discoloring, especially due to the fact that the interfaces of the two components joined together are firmly joined to each other, which impedes dirt and bacteria seeping into the end part.

The second objective consists in the fact that a tip with exceptionally progressive visual and touch characteristics regarding the step from the support arm is formed. In this case, a higher level of comfort for the wearer of the spectacles is achieved, since the perception of the part of support arm which is in contact is reduced, thus leading to a more pleasant sensation.

The third objective, which again regards the increase in the level of comfort, is due to the effect of the wide range of consistency and flexibility of the materials used to coat the support arm, which may be chosen beforehand, in order to meet and satisfy the specific, individual requirements of the wearer. Regarding this matter, it must be pointed out that the procedure also makes it possible to reduce the thickness of the coating material.

The fourth objective regards the flexibility of the production which means that a wide range of colors may be obtained, which may also be achieved by repeated immersion, and with mixtures which are different from each other. Also, it is possible to add products which, on the one hand, guarantee a high degree of non-toxicity and with anti-bacterial characteristics, while on the other hand form a filter against gamma A ultra-violet rays.

The fifth objective regards the fact that that it is possible to coat even support arms which have a complicated shape. For example, it is possible to coat support arms which have either a curly or spiral shape (or already simply bent into shape), which are usually impossible to coat using traditional methods.

To sum up, with reduced overall costs and a lower impact on the environment compared with previous solutions, it is possible to manufacture an item which has a good technological content.

These and other advantages will be demonstrated in the following detailed description and attached schematic drawings of various ways of applying the solution, the details of which are intended to be an example and not a limitation.

### BRIEF DESCRIPTION OF THE SEVERAL VIEWS OF THE DRAWINGS

FIG. 1 is a side view of the first example of support arm in metallic wire, with the end part covered by a tip according to the procedure described above.

FIG. 2 is a side view of the first example of support arm along the A-A section in FIG. 1.

FIG. 3 is a side view of the second example of support arm in metallic wire, with the end part covered by a variation of tip formed according to the procedure described above.

FIG. 4 is a side view of the first example of support arm along the B-B section in FIG. 3.

FIG. 5 is a side view of the third example of support arm in metallic wire, with the end portion shaped and covered according to the procedure described above.

FIG. 6 is a diagram which shows the procedure described above to form a support arm in metallic wire with the end portion covered by a tip.

FIG. 7 is a diagram of a variation of the procedure described above to form a support arm in metallic wire with the end portion covered by a tip.

FIG. 8 is a further diagram of a variation of the procedure described above to form a support arm in metallic wire with the end portion covered by a tip with a droplet.

FIG. 9 is a diagram of another variation of the procedure described above to form a support arm in metallic wire with the end portion covered by a tip.

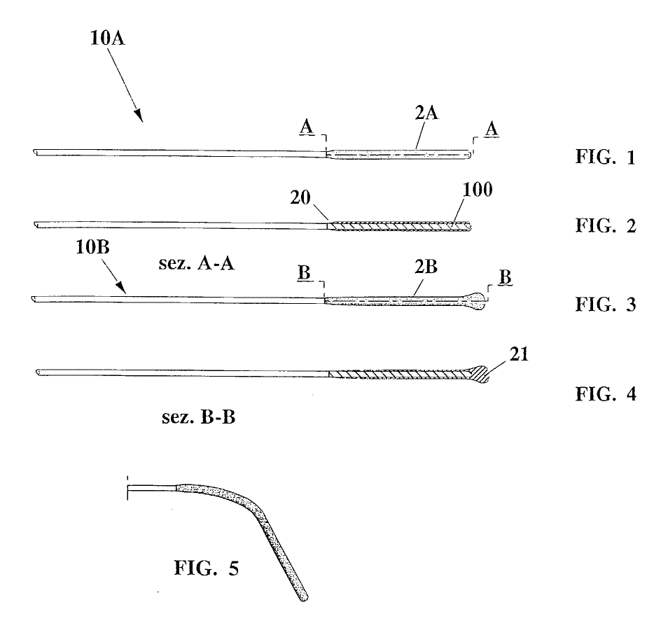

### DETAILED DESCRIPTION OF THE INVENTION

With reference to the drawings, note how a support arm 10A and 10B, in this case in metallic wire, has the end portion 100 covered with a tip in polymer 2A and 2B, which is formed by immersion. In one of the examples, tip 2A is of a straight type with a more or less constantly round section, with the mouth 20 in a tapered or conical shape. In the second example, tip 2B, note that it is straight along only the first part, while it finishes in correspondence with one of the ends which is enlarged to form a droplet shape 21.

Going more into detail, the procedure which is the object of this invention foresees a work cycle which includes, following a flow from upstream to downstream, at least phases (a), (b), (c) and

(d), to which phases (e), (f) and (g) may be added.

Phase (a)

It requires the preparation of a bath 3 which includes a liquid solution. In one example, the said solution may be made up of vinyl ether resin, such as PVC PLASTISOL mono-component, for example. As an alternative, the liquid solution may include a silicon composite, or a mono-component acrylic resin, composite epoxy enamel, rubber which is liquefied with solvent, or be made up of polyurefine, such as ethylene resin, polypropylene or polyurethane resin. In order to improve the quality of the liquid solution, it is also possible to add anti-bacteria products or coloring agents.

Phase (b)

The next step is to move the support arm without the coating 1 towards the bath 3 and to immerse it to a pre-set depth (p). In the examples illustrated, the depth (p) is determined as a function of a typical length of a conventional tip, that is, approximately 6-7 cm.

Phase (c)

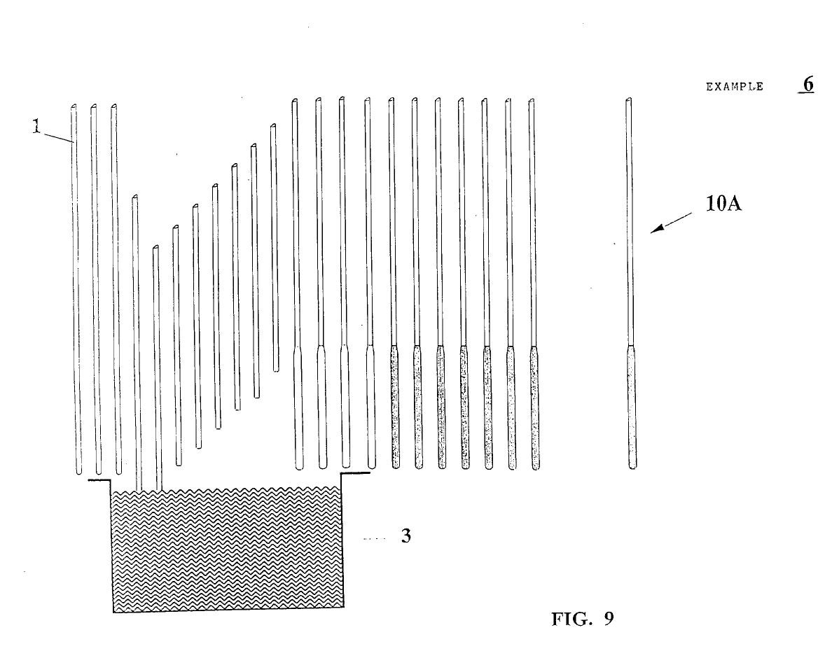

After the support arm 1 has been immersed, it is lifted out of the bath 3 at a pre-set speed. According to the speed at which the support arm 1 is extracted from the bath 3, (see FIGS. 7 and 8, for example), it is possible to form a support arm with a tip 2A which has a constant thickness 10A, or a support arm 10B with a tip 2B which is enlarged at the end in the form of a droplet 21. For example, to form the droplet-type tip 2B, the extraction from the bath 3 is carried out at a slow but constant speed.

Phase (d)

This phase foresees a further movement of the support arm 10A or 10B towards a solidification station 5.

Other phases may be added to these initial phases, according to the type of operation to be carried out and according to the type of material used in the bath 3. In particular, phase (f), which is to be carried out before phase (a), is advisable in any case, and may consist in the application of a special primer in correspondence with the portion of support arm to be coated, according to the type of bath foreseen in the successive phase (a).

The following examples are an indication of additional or complementary phases which may be carried out to help obtain good results.

### Example 1-1A

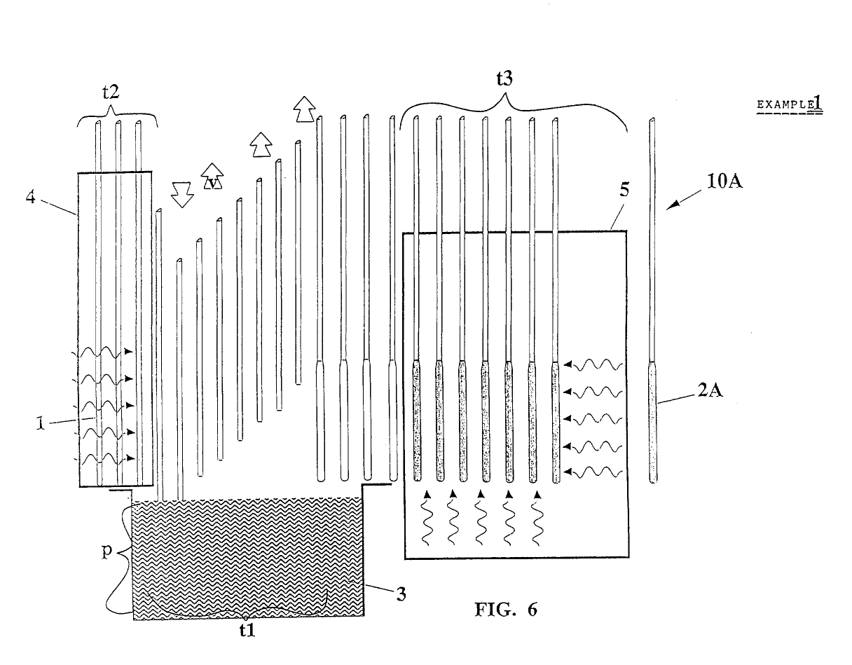

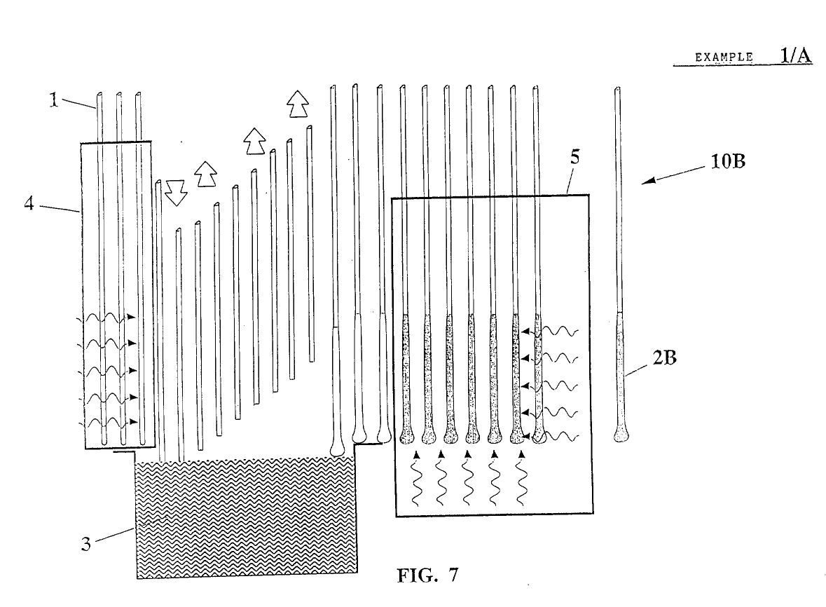

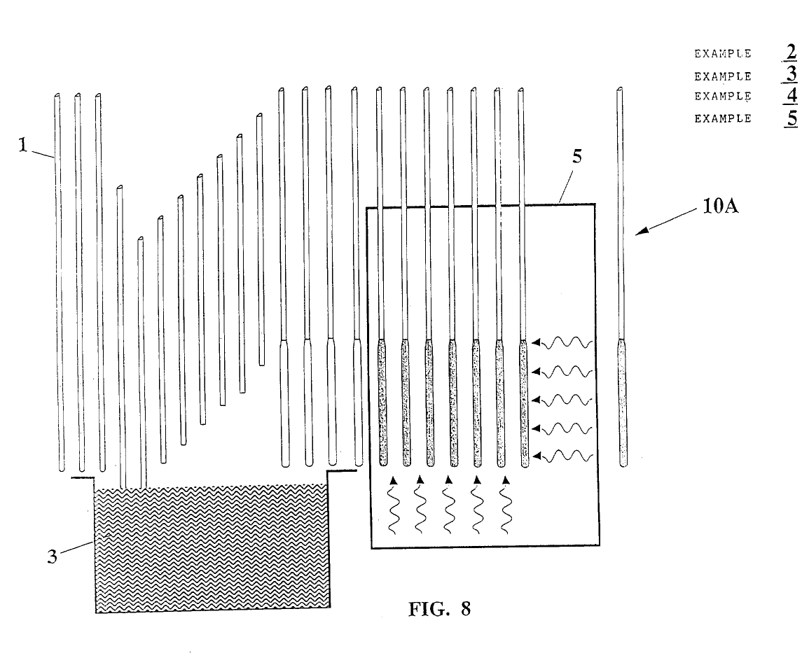

### (FIGS. 6 and 7)

In this example, a support arm in metallic wire with a tip of type 10A or 10B formed from liquid PVC is considered. The corresponding bath phase (a) is prepared. In this case, the support arm without the coating 1 has to be pre-heated in a heating unit 4, phase (g). Going further into detail, prior to coating, the support arm 1 is initially heated up to a temperature of 140° C. and is then immersed in the bath 3, phase (b), passed through phase (c) and then phase (d), where solidification is carried out by polymerization (gelling) in an oven 5 at a temperature of between 130° C. and 190° C. for approximately 6 minutes.

### Example 2

### (FIG. 8)

In this example, a support arm in metallic wire with a tip of type 10A or 10B formed from silicone is considered. The corresponding bath phase (a) is prepared. In this case, it is not necessary to pre-heat the support arm prior to coating 1, and the sequence continues directly with phase (b) where the support arm without the coating 1 is immersed while cold in the bath 3 of silicone composite. Then, phase (c) is carried out, followed by phase (d), where solidification is carried out through cross-linking in an oven 5 at a temperature of up to more than 400° C., or as an alternative, at room temperature, but obviously more time is required.

### Example 3

### (FIG. 8)

In this example, a support arm in metallic wire with a tip of type 10A or 10B formed from acrylic resin is considered. The corresponding bath phase (a) is prepared. In this case, the sequence continues directly with phase (b) where the support arm without the coating 1 is immersed while it is cold in the bath 3 of acrylic resin (mono-component). Then, phase (c) is carried out followed by phase (d), where solidification is carried out through reticulation in an oven 5 at a temperature of from room temperature up to approximately 180° C.

### Example 4

### (FIG. 8)

In this example, a support arm in metallic wire with a tip of type 10A or 10B formed from enamel is considered. The corresponding bath phase (a) is prepared. Similarly in this case, the sequence continues directly with phase (b), where the support arm without the coating 1 is immersed while it is cold, and not necessarily pre-heated, in the bath 3 of composite epoxy enamel (lacquer). Then, phase (c) is carried out followed by phase (d), where solidification is carried out through reticulation in an oven 5 at a temperature of between 20° C. and 60° C.

### Example 5

### (FIG. 8)

In this example, a support arm in metallic wire with a tip of type 10A or 10B formed in rubber is considered. The corresponding bath phase (a) is prepared. Similarly in this case, the sequence continues directly with phase (b), where the support arm without the coating 1 is immersed while it is cold in the bath 3 of rubber which is made fluid with solvent. Then, phase (c) is carried out followed by phase (d), where solidification is carried out through vulcanization at a temperature of between 100° C. and 200° C.

### Example

### (FIG. 8)

In this example, a support arm in metallic wire with a tip of type 10A or 10B formed in polyurefine is considered. The corresponding bath phase (a) is prepared. Similarly in this case, the sequence continues directly with phase (b), where the support arm without the coating 1 is immersed while it is cold in the bath 3 of polyurefine. In this case, the bath 3 is heated up to a temperature of between 170° C. and 190° C. Then, phase (c) is carried out followed by phase (d), where solidification is carried out at room temperature.

Finally, it is also possible to carry out repeated dips in correspondence with a support arm in metallic wire with a tip of type 10A or 10B, by carrying out at least one phase (e), which consists in repeating phases (b), (c) and (d) at one's own discretion. The repetitive phase (e) described above may also be preceded by replacing bath 3 with another bath phase (a), which includes a different liquid solution.

The cycle described above with the said work phases, (a), (b), (c), (d) and (e) as with (f) and (g) respectively, may be controlled by a process control unit. The said control unit has at least one electronic circuit-board, with a graphics interface through which it is possible to set the cycle and, therefore, the work phases of the support arm. Going further into detail, various parameters may be considered, such as the immersion depth (p) of the support arm 1 and its immersion/extraction speed (v), and also the time (t1) it is left in the bath 3. The said control unit is also used to control the time (t2) and (t3) which is put in correlation with the relative heating temperature of the respective heating units 4 and 5.

I claim:

1. Procedure for the formation of a coating element, formed directly in correspondence with a support arm for spectacles, characterised by the fact a work cycle foresees at least the following phases:
(a) preparation of a bath with a liquid solution which includes a polymer;
(b) the immersion in the said bath (a) to a pre-set depth of at least the end portion of a support arm in metallic wire for spectacles;
(c) removal of the support arm from the said bath, according to a predetermined speed;
(d) movement of the support arm towards a solidification station of the portion immersed in the bath (a) and its successive solidification.

2. Procedure for the formation of a coating element according to claim 1, characterised by the fact that phase (f), which is carried out prior to phase (a), consists in the application of a special primer according to the type of bath foreseen in the successive phase (a) in correspondence with the portion of support arm to be coated.

3. Procedure for the formation of a coating element according to claims 1 and 2, characterised by the fact that there is a phase (e) carried out after phase (d), which includes the repetition of phases (b), (c) and (d).

4. Procedure for the formation of a coating element according to claim 1, characterised by the fact that the bath in phase (a) includes a liquid solution made up of mono-component vinyl ether resin, silicone composite, mono-component acrylic resin, composite epoxy enamel (lacquer) or rubber which is liquefied with solvent, or is made up of polyurefine or polyurethane resin.

5. Procedure for the formation of a coating element according to claims 1, 2 and 4, characterised by the fact that, between phase (a) and phase (b), there is a further phase (g) which includes the pre-heating of the semi-finished support arm without the coating.

6. Procedure for the formation of a coating element according to the previous claims, characterised by the fact that phase (d) foresees a solidification station which is made up of an oven.

7. Procedure for the formation of a coating element according to the previous claims, characterised by the fact that the liquid solution in the bath includes additives such as an anti-bacteria product and/or filters against gamma A ultraviolet rays and/or colouring agents.

8. Procedure for the formation of a coating element according to the previous claims, characterised by the fact it uses an electronic circuit-board which takes into consideration various parameters, such as the immersion depth of the support arm and its immersion/extraction speed, and also the time it is left in the bath, and whose scope is to control the time which is put in correlation with the relative heating temperature of the respective heating units.

9. Procedure for the formation of a coating element according to claims 1, 2, 5 and 6, characterised by the fact that, to form a support arm with a tip made from liquid PVC, the following succession of phases is foreseen:
(a) preparation of a bath with a liquid solution which includes PVC;
(g) pre-heating of the support arm to be coated up to a temperature of 140° C.;
(b) the immersion in the said bath (a) according to a pre-set depth of at least the end portion of a support arm for spectacles;
(c) removal of the support arm from the said bath, according to a predetermined speed;
(d) movement of the support arm towards a heating unit for the portion immersed in the bath (a) and its successive polymerisation at a temperature of between 130° C. and 190° C.

10. Procedure for the formation of a coating element according to claims 1, 2 and 4, characterised by the fact that, to form a support arm with a tip made from silicone, the following succession of phases is foreseen:
(a) preparation of a bath with a liquid solution which includes silicone;
(b) the immersion in the said bath (a) according to a pre-set depth of at least the end portion of a support arm for spectacles;
(c) removal of the support arm from the said bath, according to a predetermined speed;
(d) movement of the support arm towards a heating unit for the portion immersed in the bath (a) and its successive reticulation at a temperature of up to 400° C.

11. Procedure for the formation of a coating element according to claims 1, 2 and 4, characterised by the fact that, to form a support arm with a tip made from acrylic resin, the following succession of phases is foreseen:
(a) preparation of a bath with a liquid solution which includes acrylic resin;
(b) the immersion in the said bath (a) according to a pre-set depth of at least the end portion of a support arm for spectacles;
(c) removal of the support arm from the said bath, according to a predetermined speed;
(d) movement of the support arm towards a solidification station at a temperature of from room temperature up to approximately 180° C.

12. Procedure for the formation of a coating element according to claims 1, 2 and 4, characterised by the fact that, to form a support arm with a tip made from enamel, the following succession of phases is foreseen:
(a) preparation of a bath with a liquid solution which includes epoxy enamel (lacquer);
(b) the immersion in the said bath (a) according to a pre-set depth of at least the end portion of a support arm for spectacles;
(c) removal of the support arm from the said bath, according to a predetermined speed;
(d) the support arm is then moved to an oven for its successive reticulation at a temperature of between 20° C. and 60° C.

13. Procedure for the formation of a coating element according to claims 1, 2 and 4, characterised by the fact that, to form a support arm with a tip made from rubber, the following succession of phases is foreseen:
(a) preparation of a bath with a liquid solution which includes rubber which is made fluid;
(b) the immersion in the said bath (a) according to a pre-set depth of at least the end portion of a support arm in metallic wire for spectacles;
(c) removal of the support arm from the said bath, according to a predetermined speed;
(d) its successive vulcanisation at a temperature of between 100° C. and 200° C.

14. Procedure for the formation of a coating element according to claims 1, 2 and 4, characterised by the fact that, to form a support arm with a tip made from polyurefine, the following succession of phases is foreseen:
(a) preparation of a bath with a liquid solution which includes at least one polyurefine component;
(b) the immersion in the said bath (a), which is preheated up to a temperature of between 170° C. and 190° C., according to a pre-set depth of at least the end portion of a support arm for spectacles;
(c) removal of the support arm from the said bath, according to a predetermined speed;
(d) its successive solidification is carried out at room temperature.

15. Tip for a support arm formed according to the previous claims, characterised by the fact that it is of a straight type with a more or less constantly round section, and which has a mouth in a tapered or conical shape at one end, and a hemispherical shape at the other end.

16. Tip for a support arm formed according to the previous claims, characterised by the fact that it is of a straight type with a more or less constantly round section, and which has a mouth in a tapered or conical shape at one end, and a droplet shape at the other end.

17. Support arm with a coating element, characterised by the fact that the end portion of the support arm is coated with a polymer tip which is formed by immersion, with the said tip being of the straight type with a more or less constantly round section and with an opening which is tapered, that is, conical.

18. Support arm with a coating element according to the previous claim, characterised by the fact that the tip is straight along only the first part, while it finishes in correspondence with the extremity of the support arm with an enlarged portion of material in the shape of a droplet.
